(19) United States
(12) Patent Application Publication
(10) Pub. No.: US 2016/0072334 A1
(43) Pub. Date: Mar. 10, 2016

(54) WIRELESS CHARGING DEVICE AND METHOD THEREOF

(71) Applicant: Wistron Corporation, New Taipei City (TW)

(72) Inventor: Te-Lung Wu, New Taipei City (TW)

(21) Appl. No.: 14/543,907

(22) Filed: Nov. 18, 2014

(30) Foreign Application Priority Data
Sep. 5, 2014 (TW) 103130780

(51) Int. Cl. H02J 7/02; H02J 7/00

(52) U.S. Cl. CPC H02J 7/025; H02J 7/0044

(57) ABSTRACT

A wireless charging device including a housing, a coil array and a controller is provided. The housing includes a carrying surface, and the coil array is disposed in the housing. When a first electronic device and a second electronic device located on the carrying surface are respectively detected by a first coil and a second coil in the coil array, the controller generates first location information corresponding to the first coil and second location information corresponding to the second coil. The wireless charging device drives the first coil by using the first location information, so as to perform a wireless charging operation to the first electronic device. After the wireless charging operation of the first electronic device is completed, the wireless charging device drives the second coil by using the second location information, so as to perform the wireless charging operation to the second electronic device.

### CROSS-REFERENCE TO RELATED APPLICATION

This application claims the priority benefit of Taiwan application serial no. 103130780, filed on Sep. 5, 2014. The entirety of the above-mentioned patent application is hereby incorporated by reference herein and made a part of this specification.

### BACKGROUND

1. Technical Field

The invention relates to a charging device and a method thereof, and particularly relates to a wireless charging device and a method thereof.

2. Related Art

Generally, electronic devices of different models or brands cannot share a same wired charger. Correspondingly, a user has to take different wired chargers for different electronic devices, which is inconvenient in usage. Therefore, wireless charging technology gradually draws attention in recent years, and various manufacturers compete with each other in design of the wireless charger. However, the existing wireless charger can only charge a single electronic device. Moreover, when multiple electronic devices need to be charged, the user has to replace the electronic devices in a manual manner, which causes inconvenience in utilization.

### SUMMARY

The invention is directed to a wireless charging device and a method thereof, by which a wireless charging operation is performed to all of electronic devices to be charged by using location information, so as to improve utilization convenience of the wireless charging device.

The invention provides a wireless charging device including a housing, a coil array and a controller. The housing has a carrying surface, and the coil array is disposed in the housing. When a first electronic device and a second electronic device located on the carrying surface are respectively detected by a first coil and a second coil in the coil array, the controller generates first location information corresponding to the first coil and second location information corresponding to the second coil. The wireless charging device drives the first coil by using the first location information, so as to perform a wireless charging operation to the first electronic device. After the wireless charging operation of the first electronic device is completed, the wireless charging device drives the second coil by using the second location information, so as to perform the wireless charging operation to the second electronic device.

According to another aspect, the invention provides a wireless charging method, which is adapted to a wireless charging device having a coil array, and the wireless charging method includes following steps. When a first electronic device and a second electronic device are respectively detected by a first coil and a second coil in the coil array, first location information corresponding to the first coil and second location information corresponding to the second coil are stored. The first coil is driven by using the first location information, so as to perform a wireless charging operation to the first electronic device. After the wireless charging operation of the first electronic device is completed, the second coil is driven by using the second location information, so as to perform the wireless charging operation to the second electronic device.

The invention provides a wireless charging device including a housing, a coil and a sensor. The housing has a carrying surface, and the coil is disposed in the housing. When a first electronic device and a second electronic device located on the carrying surface are detected, the sensor generates first location information and second location information according to a detection result. The wireless charging device moves and drives the coil by using the first location information, so as to perform a wireless charging operation to the first electronic device. Moreover, after the wireless charging operation of the first electronic device is completed, the wireless charging device again moves and drives the coil by using the second location information, so as to perform the wireless charging operation to the second electronic device.

According to another aspect, the invention provides a wireless charging method, which is adapted to a wireless charging device having a coil, and the wireless charging method includes following steps. When a first electronic device and a second electronic device are detected, first location information and second location information are generated according to a detection result. The first coil is moved and driven by using the first location information, so as to perform a wireless charging operation to the first electronic device. After the wireless charging operation of the first electronic device is completed, the second coil is moved and driven by using the second location information, so as to perform the wireless charging operation to the second electronic device.

According to the above descriptions, in the wireless charging device and the wireless charging method of the invention, all of the electronic devices to be charged are first detected, and related location information is generated according to the detection result. Moreover, in the wireless charging device and the wireless charging method of the invention, the wireless charging operation is performed to all of the electronic devices to be charged by using the location information. In this way, wireless charging operations of a plurality of electronic devices are completed without manually replacing the electronic devices by the user, which avails improving utilization convenience of the wireless charging device.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block schematic diagram of a wireless charging device according to an embodiment of the invention.

FIG. 2 is an appearance schematic diagram of a wireless charging device according to an embodiment of the invention.

FIG. 3 is a flowchart illustrating a wireless charging method according to an embodiment of the invention.

FIG. 4 is a block schematic diagram of a wireless charging device according to another embodiment of the invention.

FIG. 5 is an appearance schematic diagram of a wireless charging device according to another embodiment of the invention.

FIG. 6 is a flowchart illustrating a wireless charging method according to another embodiment of the invention.

### DETAILED DESCRIPTION OF DISCLOSED EMBODIMENTS

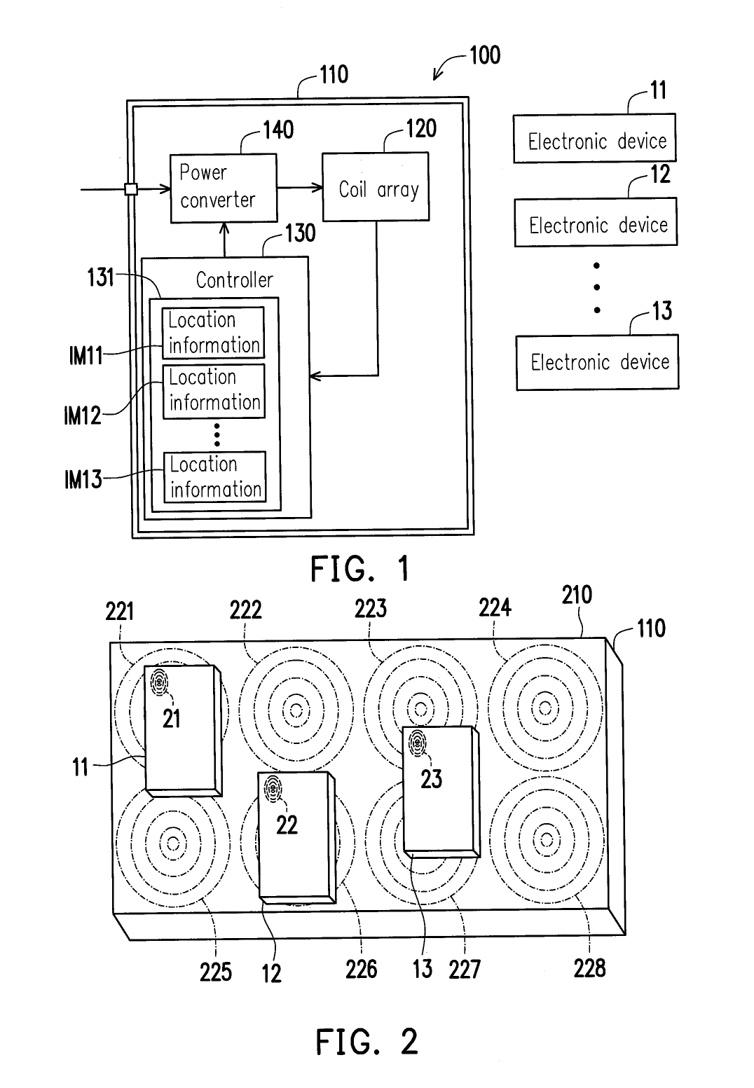

FIG. 1 is a block schematic diagram of a wireless charging device according to an embodiment of the invention. As shown in FIG. 1, the wireless charging device 100 can perform wireless charging operations to a plurality of electronic devices 11-13, and the wireless charging device 100 includes a housing 110, a coil array 120, a controller 130 and a power converter 140, wherein the coil array 120, the controller 130 and the power converter 140 are disposed in the housing 110.

The coil array 120 detects whether electronic devices to be charged exist at periphery of the wireless charging device 100. For example, when the electronic devices 11-13 are located adjacent to the coil array 120, the coil array 120 detects the electronic devices 11-13 and transmits a plurality of identification signals in response to the detection result. The controller 130 generates a plurality of location information IM11-IM13 according to the identification signals. Moreover, the controller 130 reads the plurality of location information one-by-one, and controls the power converter 140 according to the read location information, such that the power converter 140 converts an external alternating current (AC) signal into a resonant current for driving the coil array 120. In this way, the wireless charging device 100 can perform a wireless charging operation to each of the electronic devices 11-13.

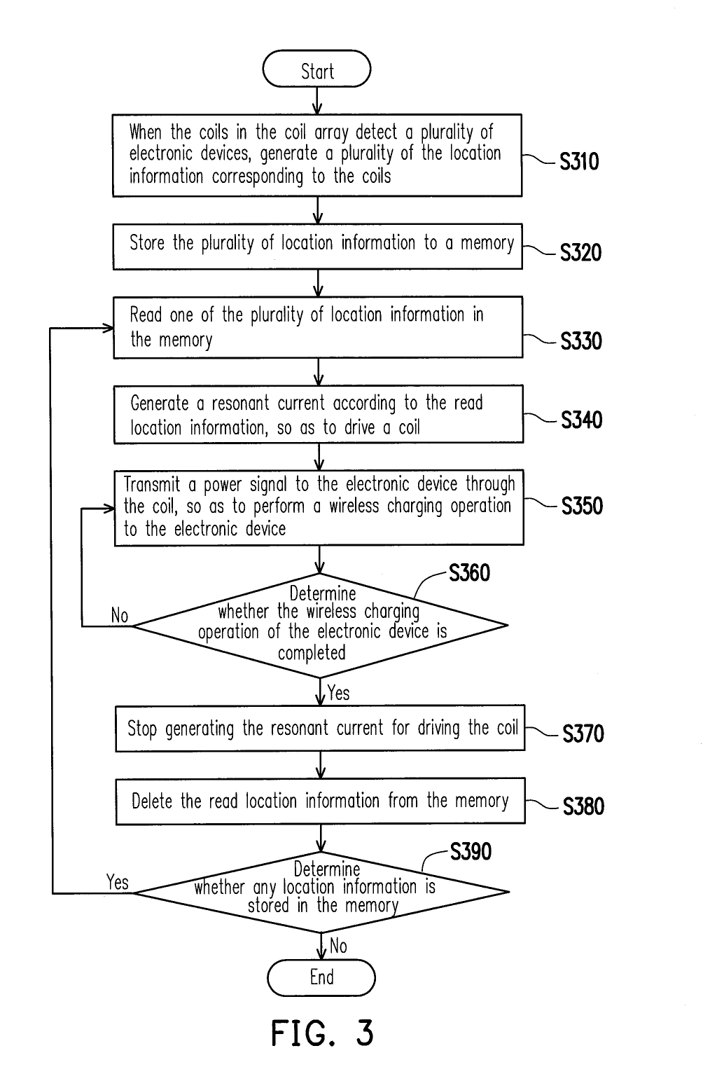

In view of a hardware structure, the housing 110 has a carrying surface, and the carrying surface of the housing 110 can be used to carry the electronic devices 11-13. For example, FIG. 2 is an appearance schematic diagram of the wireless charging device according to an embodiment of the invention. As shown in FIG. 2, the housing 110 has a carrying surface 210, and the electronic devices 11-13 can be disposed on the carrying surface 210. Further, the coil array 120 includes a plurality of coils 221-228. The electronic devices 11-13 can be respectively a mobile device, and respectively have a receiving coil. For simplicity's sake, in FIG. 2, the coils 221-228 configured in the housing 110 and the receiving coils 21-23 configured in the electronic devices 11-13 are indicated by dot lines.

As shown in FIG. 2, the coils 221-228 are periodically arranged under the carrying surface 210. Moreover, a location lookup table is stored in the controller 130, and the location lookup table records location information of the periodically arranged coils 221-228. In an application, the receiving coils 21-23 in the electronic devices 11-13 are respectively located adjacent to the coils 221, 226 and 223 in the coil array 120. Therefore, wireless transmission can be performed between the wireless charging device 100 and the electronic devices 11-13 through electromagnetic induction between the coils 221, 226, 223 and the receiving coils 21-23.

In order to fully convey the spirit of the invention to those skilled in the art, an embodiment is further provided below for description. FIG. 3 is a flowchart illustrating a wireless charging method according to an embodiment of the invention. The wireless charging operation between the wireless charging device 100 and the electronic devices 11-13 is described below with reference of FIG. 1 to FIG. 3, and for simplicity's sake, the number of the electronic devices 11-13 is assumed to be 3 in following description.

In view of operation, when the electronic devices 11-13 are disposed on the carrying surface 210, the wireless charging device 100 can detect the electronic devices 11-13 through the coils 221, 226 and 223. The controller 130 receives a plurality of identification signals transmitted by the receiving coils 21-23 through the coils 221, 226 and 223. Moreover, the controller 130 looks up the position lookup table stored therein according to the identification signals, and generates a plurality of location information IM11-IM13 corresponding to the coils 221, 226 and 223 according to a lookup result.

In other words, as shown in step S310 of FIG. 3, when the coils 221, 226 and 223 in the coil array 120 respectively detect the electronic devices 11-13 located on the carrying surface 210, the controller 130 generates the plurality of location information IM11-IM13 corresponding to the coils 221, 226 and 223. Moreover, the controller 130 includes a memory 131, and as shown in step S320, the controller 130 stores the plurality of location information IM11-IM13 corresponding to the coils 221, 226 and 223 into the memory 131.

As shown in step S330, the controller 130 reads one of the plurality of location information from the memory 131, for example, the location information IM11 corresponding to the coil 221. Moreover, as shown in step S340, the controller 130 controls the power converter 140 according to the read location information IM11. In this way, the power converter 140 generates a resonant current to drive the coil 221. Moreover, as shown in step S350, the coil 221 driven by the resonant current can transmit a power signal to the electronic device 11 to perform the wireless charging operation to the electronic device 11. In other words, in the aforementioned steps S330 to S350, the wireless charging device 100 can drive the coil 221 located under the electronic device 11 by using the location information IM11, so as to perform the wireless charging operation to the electronic device 11.

During the wireless charging operation, the electronic device 11 generates a state signal according to a charging state thereof and transmits the state signal through the receiving coil 21. Therefore, as shown in step S360, the controller 130 receives the state signal from the electronic device 11 through the coil 221 and determines whether the wireless charging operation of the electronic device 11 is completed according to the state signal. When the wireless charging operation of the electronic device 11 is not completed, as shown in step S350, the wireless charging device 100 continually transmits the power signal to the electronic device 11 through the coil 221.

Furthermore, when the wireless charging operation of the electronic device 11 is completed, as shown in step S370 and step 380, the controller 130 controls the power converter 140 to stop generating the resonant current for driving the coil 221, and the controller 130 deletes the read location information IM11 from the memory 131. Moreover, as shown in step S390, the controller 130 determines whether the memory 131 stores remained location information. If the memory 131 still stores the remained location information, the wireless charging device 100 repeats the aforementioned steps S330 to S380 to perform the wireless charging operation to another electronic device.

For example, after the location information IM11 in the memory 131 is deleted, the remained location information in the memory 131 is IM12 and IM13. Therefore, after the location information IM11 in the memory 131 is deleted, as shown in step S330, the controller 130 again reads the location information from the memory 131, for example, the location information IM12 corresponding to the coil 226.

As shown in step S340, the controller 130 controls the power converter 140 according to the read location information IM12, such that the power converter 140 generates a resonant current to drive the coil 226. Moreover, as shown in step S350, the coil 226 driven by the resonant current transmits a power signal to the electronic device 12 to perform the wireless charging operation to the electronic device 12. In other words, in the aforementioned steps S330 to S350, the wireless charging device 100 can drive the coil 226 located under the electronic device 12 by using the location information IM12, so as to perform the wireless charging operation to the electronic device 12.

Moreover, the electronic device 12 transmits a state signal according to a charging state thereof. Therefore, as shown in step S360, the controller 130 receives the state signal from the electronic device 12 through the coil 226, and determines whether the wireless charging operation of the electronic device 12 is completed according to the state signal. When the wireless charging operation of the electronic device 12 is not completed, as shown in step S350, the wireless charging device 100 continually transmits the power signal to the electronic device 12 through the coil 226. Furthermore, when the wireless charging operation of the electronic device 12 is completed, as shown in step S370 and the step S380, the power converter 140 stops generating the resonant current for driving the coil 226, and the controller 130 deletes the read location information IM12 from the memory 131.

After the location information IM 12 in the memory 131 is deleted, only the location information IM13 is remained in the memory 131. Now, the wireless charging device 100 repeats the aforementioned steps S330 to S380 to perform the wireless charging operation to the electronic device 13. In detail, as shown in steps S330 to S350, the controller 130 again reads the location information from the memory 131, for example, the location information IM13 corresponding to the coil 223, such that the wireless charging device 100 drives the coil 223 located under the electronic device 13 by using the location information IM13, so as to perform the wireless charging operation to the electronic device 13.

Moreover, as shown in step S360, the controller 130 determines whether the wireless charging operation of the electronic device 13 is completed according to the state signal transmitted back by the electronic device13. When the wireless charging operation of the electronic device 13 is not completed, the wireless charging device 100 continually transmits the power signal to the electronic device 13 through the coil 223. Furthermore, when the wireless charging operation of the electronic device 13 is completed, the power converter 140 stops generating the resonant current for driving the coil 223, and the controller 130 deletes the read location information IM13 from the memory 131. After the location information IM13 in the memory 131 is deleted, none location information is remained in the memory 131, and the wireless charging device 100 stops the wireless charging operations on the electronic devices 11-13.

In overall, the wireless charging device 100 first detects all of the electronic devices 11-13 to be charged, and generates the location information IM11-IM13 according to the detection result. Moreover, the wireless charging device 100 performs the wireless charging operation to each of the electronic devices 11-13 to be charged according to the location information IM11-IM13. For example, the wireless charging device 100 first drives the coil 221 under the electronic device 11 by using the location information IM11, so as to perform the wireless charging operation to the electronic device 11. After the wireless charging operation of the electronic device 11 is completed, the wireless charging device 100 drives the coil 226 under the electronic device 12 by using the location information IM12, so as to perform the wireless charging operation to the electronic device 12. In this way, the wireless charging operations of the electronic devices 11-13 can be completed without manually replacing the electronic devices 11-13 by the user, which avails improving the utilization convenience of the wireless charging device 100.

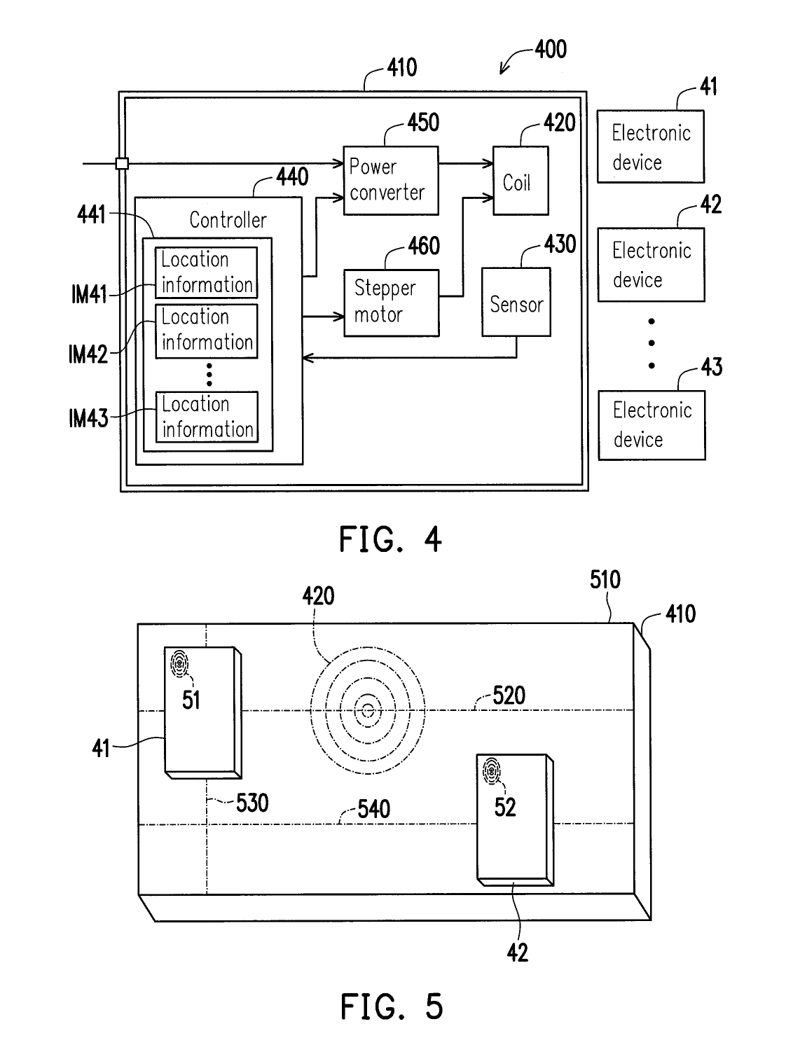

FIG. 4 is a block schematic diagram of a wireless charging device according to another embodiment of the invention. As shown in FIG. 4, the wireless charging device 400 can perform the wireless charging operations to a plurality of electronic devices 41-43, and the wireless charging device 400 includes a housing 410, a coil 420, a sensor 430, a controller 440, a power converter 450 and a stepper motor 460, wherein the coil 420, the sensor 430, the controller 440, the power converter 450 and the stepper motor 460 are disposed in the housing 410.

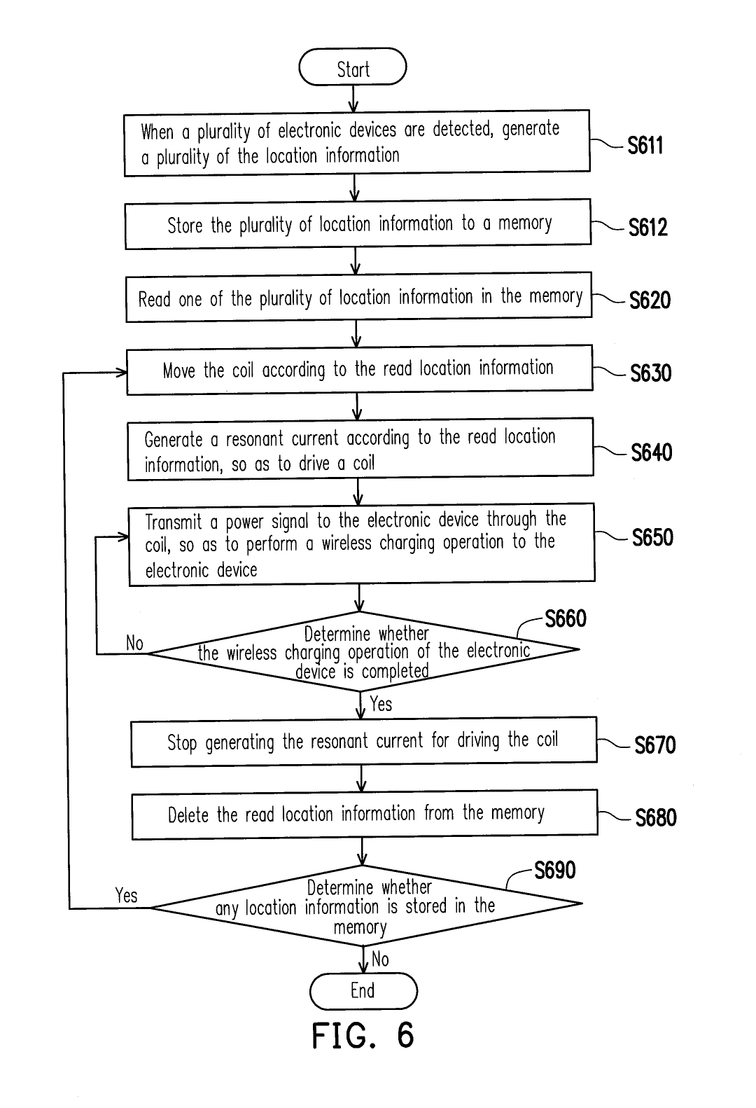

In view of a hardware structure, the housing 410 has a carrying surface, and the carrying surface of the housing 410 can be used to carry the electronic devices 41-43. For example, FIG. 5 is an appearance schematic diagram of the wireless charging device according to another embodiment of the invention. For simplicity's sake, in FIG. 5, only two electronic devices 41 and 42 are illustrated, and the coil 420 configured in the housing 410 and the receiving coils 51-52 configured in the electronic devices 41 and 42 are indicated by dot lines. As shown in FIG. 5, the housing 410 has a carrying surface 510, and the electronic devices 41 and 42 are placed on the carrying surface 510. Moreover, the electronic devices 41 and 42 can be respectively a mobile device, and respectively have a receiving coil.

In view of operation, the sensor 430 can detect whether electronic devices to be charged exist at periphery of the wireless charging device 100, and the sensor 430 can generate corresponding location information according to locations of the detected electronic devices. For example, when the electronic devices 41-43 are located within a sensing range of the sensor 430, the sensor 430 can detect the electronic devices 41-43, and generates a plurality of location information IM41-IM43 according to the detection result. The sensor 430 is, for example, an infrared sensor, and in another embodiment, the sensor 430 can be configured out of the housing 410. The controller 440 controls the power converter 450 according to the plurality of location information, and the power converter 450 converts an external AC signal into a resonant current for driving the coil 420. Moreover, the controller 440 also controls the stepper motor 460 according to the plurality of location information, such that the stepper motor 460 drives the coil 420 to move in the housing 410.

In order to fully convey the spirit of the invention to those skilled in the art, an embodiment is further provided below for description. FIG. 6 is a flowchart illustrating a wireless charging method according to another embodiment of the invention. The wireless charging operations between the wireless charging device 400 and the electronic devices 41 and 42 is described below with reference of FIG. 4 to FIG. 6. As shown in step S611, when the sensor 430 detects the electronic devices 41 and 42 located on the carrying surface 510, the sensor 430 generates the location information IM41 and IM42 corresponding to the electronic devices 41 and 42 according to the detection result. Moreover, the controller 440 includes a memory 441, and as shown in step S612, the controller 440 stores the location information IM41 and IM42 to the memory 441.

As shown in step S620, the controller 440 reads one of the plurality of location information from the memory 441, for example, the location information IM41 corresponding to the electronic device 41. Moreover, as shown in step S630, the controller 440 controls the stepper motor 460 according to the read location information IM41, such that the coil 420 is moved to the underside of the electronic device 41 by the stepper motor 460. For example, as shown in FIG. 5, the housing 410 of the wireless charging device 400 includes a plurality of tracks, for example, tracks 520-540. Moreover, the coil 420 driven by the stepper motor 460 can be moved along the tracks in the housing 410. For example, the coil 420 can be moved to the underside of the electronic device 41 along the track 520.

As shown in step S640, the controller 440 controls the power converter 450 according to the read location information IM41, and the power converter 450 generates the resonant current for driving the coil 420. Besides, as shown in step S650, the coil 420, which is located under the electronic device 41, is driven by the resonant current and transmits a power signal to the electronic device 41 to perform the wireless charging operation to the electronic device 41. In other words, in the aforementioned steps S620 to S650, the wireless charging device 400 can move and drive the coil 420 by using the location information IM41, so as to perform the wireless charging operation to the electronic device 41.

During the wireless charging operation, the electronic device 41 generates a state signal according to a charging state thereof and transmits the state signal through the receiving coil 51. Therefore, as shown in step S660, the controller 130 receives the state signal from the electronic device 41 through the coil 420, and determines whether the wireless charging operation of the electronic device 41 is completed according to the state signal. When the wireless charging operation of the electronic device 41 is not completed, as shown in step S650, the wireless charging device 400 continually transmits the power signal to the electronic device 41 through the coil 420.

Furthermore, when the wireless charging operation of the electronic device 41 is completed, as shown in step S670 and step 680, the controller 430 controls the power converter 450 to stop generating the resonant current for driving the coil 420, and the controller 440 deletes the read location information IM41 from the memory 441. Moreover, as shown in step S690, the controller 440 determines whether the memory 441 stores remained location information. If the memory 441 still stores the remained location information, the wireless charging device 400 repeats the aforementioned steps S620 to S680 to perform the wireless charging operation to another electronic device.

For example, after the location information IM41 in the memory 441 is deleted, as shown in step S620, the controller 440 again reads the location information from the memory 441, for example, the location information IM42 corresponding to the electronic device 42. Now, the controller 440 controls the stepper motor 460 and the power converter 450 according to the read location information IM42. In this way, as shown in step S630, the coil 420 is driven by the stepper motor 460 and is moved to the underside of the electronic device 42 along the tracks 530 and 540 in the housing 410. Moreover, as shown in step S640, the power converter 450 generates the resonant current for driving the coil 420. As shown in step S650, the coil 420, which is located under the electronic device 42, is driven by the resonant current and can transmit the power signal to the electronic device 42 to perform the wireless charging operation to the electronic device 42. In other words, in the aforementioned steps S620 to S650, the wireless charging device 400 can move and drive the coil 420 by using the location information IM42, so as to perform the wireless charging operation to the electronic device 42.

On the other hand, as shown in step S660, the controller 130 determines whether the wireless charging operation of the electronic device 42 is completed according to the state signal transmitted by the electronic device 42. When the wireless charging operation of the electronic device 42 is not completed, as shown in step S650, the wireless charging device 400 continually transmits the power signal to the electronic device 42 through the coil 420. Furthermore, when the wireless charging operation of the electronic device 42 is completed, as shown in step S670 and step 680, the power converter 450 stops generating the resonant current for driving the coil 420, and the controller 440 deletes the read location information IM42 from the memory 441.

After the location information IM42 in the memory 441 is deleted, none location information is remained in the memory 441, and the wireless charging device 400 stops the wireless charging operations on the electronic devices 41 and 42. In overall, the wireless charging device 400 first moves and drives the coil 420 by using the location information IM41 to perform the wireless charging operation to the electronic device 41. After the wireless charging operation of the electronic device 41 is completed, the wireless charging device 400 moves and drives the coil 420 by using the location information IM42, so as to perform the wireless charging operation to the electronic device 42. In this way, the wireless charging operations of the electronic devices 41 and 42 can be completed without manually replacing the electronic devices 41 and 42 by the user, which avails improving the utilization convenience of the wireless charging device 400.

In summary, the wireless charging device of the invention first detects all of the electronic devices to be charged, and generates the location information according to the detection result. Moreover, the wireless charging device performs the wireless charging operation to each of the electronic devices to be charged according to the generated location information. In this way, the wireless charging operations of the electronic devices are completed without manually replacing the electronic devices by the user, which avails improving utilization convenience of the wireless charging device.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A wireless charging device, comprising:
a housing, having a carrying surface;
a coil array, disposed in the housing; and
a controller, wherein when a first electronic device and a second electronic device located on the carrying surface are respectively detected by a first coil and a second coil in the coil array, the controller generates first location information corresponding to the first coil and second location information corresponding to the second coil,
wherein the wireless charging device drives the first coil by using the first location information, so as to perform a wireless charging operation to the first electronic device, and after the wireless charging operation of the first electronic device is completed, the wireless charging device drives the second coil by using the second location information, so as to perform the wireless charging operation to the second electronic device.

2. The wireless charging device as claimed in claim 1, further comprising:
a power converter, controlled by the controller to drive the coil array,
wherein the controller comprises a memory, and the controller stores the first location information and the second location information to the memory.

3. The wireless charging device as claimed in claim 2, wherein the controller reads the first location information in the memory, and controls the power converter according to the first location information, such that the power converter generates a first resonant current for driving the first coil, and the first coil is driven by the first resonant current to transmit a first power signal to the first electronic device.

4. The wireless charging device as claimed in claim 3, wherein when the wireless charging operation of the first electronic device is completed, the power converter stops generating the first resonant current, and the controller deletes the first location information in the memory.

5. The wireless charging device as claimed in claim 4, wherein after the first location information in the memory is deleted, the controller reads the second location information in the memory, and controls the power converter according to the second location information, such that the power converter generates a second resonant current for driving the second coil, and the second coil is driven by the second resonant current to transmit a second power signal to the second electronic device.

6. The wireless charging device as claimed in claim 5, wherein when the wireless charging operation of the second electronic device is completed, the power converter stops generating the second resonant current, and the controller deletes the second location information in the memory.

7. A wireless charging method, adapted to a wireless charging device having a coil array, and the wireless charging method comprising:
storing first location information corresponding to a first coil and second location information corresponding to a second coil when a first electronic device and a second electronic device are respectively detected by the first coil and the second coil in the coil array;
driving the first coil by using the first location information, so as to perform a wireless charging operation to the first electronic device; and
driving the second coil by using the second location information after the wireless charging operation of the first electronic device is completed, so as to perform the wireless charging operation to the second electronic device.

8. The wireless charging method as claimed in claim 7, further comprising:
storing the first location information and the second location information to a memory of the wireless charging device.

9. The wireless charging method as claimed in claim 8, wherein the step of driving the first coil by using the first location information, so as to perform the wireless charging operation to the first electronic device comprises:
reading the first location information in the memory;
generating a first resonant current according to the first location information, so as to drive the first coil; and
transmitting a first power signal to the first electronic device through the first coil.

10. The wireless charging method as claimed in claim 9, further comprising:
determining whether the wireless charging operation of the first electronic device is completed;
stopping generating the first resonant current when the wireless charging operation of the first electronic device is completed, and deleting the first location information in the memory; and
returning to the step of transmitting the first power signal to the first electronic device through the first coil when the wireless charging operation of the first electronic device is not completed.

11. The wireless charging method as claimed in claim 10, wherein the step of driving the second coil by using the second location information, so as to perform the wireless charging operation to the second electronic device comprises:
reading the second location information in the memory after the first location information in the memory is deleted;
generating a second resonant current according to the read second location information, so as to drive the second coil; and
transmitting a second power signal to the second electronic device through the second coil.

12. The wireless charging method as claimed in claim 11, further comprising:
determining whether the wireless charging operation of the second electronic device is completed;
stopping generating the second resonant current when the wireless charging operation of the second electronic device is completed, and deleting the second location information in the memory; and
returning to the step of transmitting the second power signal to the second electronic device through the second coil when the wireless charging operation of the second electronic device is not completed.

13. A wireless charging device, comprising:
a housing, having a carrying surface;
a coil, disposed in the housing; and
a sensor, wherein when a first electronic device and a second electronic device located on the carrying surface are detected, the sensor generates first location information and second location information according to a detection result,
wherein the wireless charging device moves and drives the coil by using the first location information, so as to perform a wireless charging operation to the first electronic device, and after the wireless charging operation of the first electronic device is completed, the wireless charging device again moves and drives the coil by using the second location information, so as to perform the wireless charging operation to the second electronic device.

14. The wireless charging device as claimed in claim 13, further comprising:
a controller, comprising a memory, wherein the controller stores the first location information and the second location information to the memory;
a stepper motor, controlled by the controller to drive the coil to move in the housing; and
a power converter, controlled by the controller to drive the coil.

15. The wireless charging device as claimed in claim 14, wherein the controller reads the first location information in the memory and controls the stepper motor and the power converter according to the read first location information, such that the coil is moved to the underside of the first electronic device by the stepper motor, and the power converter generates a first resonant current for driving the coil, wherein the coil is driven by the first resonant current to transmit a first power signal to the first electronic device.

16. The wireless charging device as claimed in claim 15, wherein when the wireless charging operation of the first electronic device is completed, the power converter stops generating the first resonant current, and the controller deletes the first location information in the memory.

17. The wireless charging device as claimed in claim 16, wherein after the first location information in the memory is deleted, the controller reads the second location information in the memory and controls the stepper motor and the power converter according to the read second location information, such that the coil is moved to the underside of the second electronic device by the stepper motor, and the power converter generates a second resonant current for driving the coil, wherein the coil is driven by the second resonant current to transmit a second power signal to the second electronic device.

18. The wireless charging device as claimed in claim 17, wherein when the wireless charging operation of the second electronic device is completed, the power converter stops generating the second resonant current, and the controller deletes the second location information in the memory.

19. A wireless charging method, adapted to a wireless charging device having a coil, and the wireless charging method comprising:
generating first location information and second location information according to a detection result when a first electronic device and a second electronic device are detected;
moving and driving the first coil by using the first location information, so as to perform a wireless charging operation to the first electronic device; and
moving and driving the second coil by using the second location information after the wireless charging operation of the first electronic device is completed, so as to perform the wireless charging operation to the second electronic device.

20. The wireless charging method as claimed in claim 19, further comprising:
storing the first location information and the second location information to a memory of the wireless charging device.

21. The wireless charging method as claimed in claim 20, wherein the step of moving and driving the first coil by using the first location information, so as to perform the wireless charging operation to the first electronic device comprises:
reading the first location information in the memory;
moving the coil according to the first location information;
generating a first resonant current according to the first location information, so as to drive the coil; and
transmitting a first power signal to the first electronic device through the coil.

22. The wireless charging method as claimed in claim 21, further comprising:
determining whether the wireless charging operation of the first electronic device is completed;
stopping generating the first resonant current when the wireless charging operation of the first electronic device is completed, and deleting the first location information in the memory; and
returning to the step of transmitting the first power signal to the first electronic device through the coil when the wireless charging operation of the first electronic device is not completed.

23. The wireless charging method as claimed in claim 22, wherein the step of moving and driving the second coil by using the second location information, so as to perform the wireless charging operation to the second electronic device comprises:
reading the second location information in the memory after the first location information in the memory is deleted;
moving the coil according to the second location information;
generating a second resonant current according to the second location information, so as to drive the coil; and
transmitting a second power signal to the second electronic device through the coil.

24. The wireless charging method as claimed in claim 23, further comprising:
determining whether the wireless charging operation of the second electronic device is completed;
stopping generating the second resonant current when the wireless charging operation of the second electronic device is completed, and deleting the second location information in the memory; and
returning to the step of transmitting the second power signal to the second electronic device through the coil when the wireless charging operation of the second electronic device is not completed.
